(19) United States
(12) Patent Application Publication
(10) Pub. No.: US 2016/0189219 A1
(43) Pub. Date: Jun. 30, 2016

(54) SIMPLIFIED OVERLAY ADS

(71) Applicants: Michael George Lenahan, Moraga, CA (US); Ben Mitchell, Oakland, CA (US); R. J. Pittman, San Francisco, CA (US); Dave Lippman, San Francisco, CA (US)

(72) Inventors: Michael George Lenahan, Moraga, CA (US); Ben Mitchell, Oakland, CA (US); R. J. Pittman, San Francisco, CA (US); Dave Lippman, San Francisco, CA (US)

(21) Appl. No.: 14/586,482

(22) Filed: Dec. 30, 2014

(51) Int. Cl. G06Q 30/02

(52) U.S. Cl. CPC G06Q 30/0256

(57) ABSTRACT

Example embodiments of the present disclosure include a system comprising a computer-readable storage medium storing at least one program and a computer-implemented method for providing simplified overlay advertisements. In example embodiments, a search string that is used to determine search results from a publication system is received. A matching process that compares each keyword in the search string to attributes of a plurality of advertisements is performed. An advertisement from the plurality of advertisements that has attributes matching the search string is determined. An image corresponding to the advertisement is presented as part a search result page, whereby the image is displayed in a same format as the search results determined from the publication system using the search string.

### FIELD

The present disclosure relates generally to data analysis and, in a specific example embodiment, to providing simplified overlay advertisements.

### BACKGROUND

Typically, when a user performs a search, the user must enter a search string and then select an “enter” key. Once the “enter” key is selected, a search system takes the entire search string and performs a search for entries that match the entire search string. The search results are typically displayed in a prominent area of a display (e.g., center). Along a periphery of the display advertisements, such as banner ads, may be provided.

### BRIEF DESCRIPTION OF DRAWINGS

Various ones of the appended drawings merely illustrate example embodiments of the present invention and cannot be considered as limiting its scope.

FIG. 1 is a block diagram illustrating an example embodiment of a network architecture of a system used to provide a dynamic content delivery search system.

FIG. 2 is a block diagram illustrating an example embodiment of a publication system.

FIG. 3 is a block diagram illustrating an example embodiment of a search engine.

FIGS. 4A-4G are example user interfaces of the dynamic content delivery search system.

FIG. 5 is a flow diagram of an example method for providing dynamic search results and relevant advertisements in a search system.

FIG. 6 is a flow diagram of an example method for providing content corresponding to a selected advertisement.

FIG. 7 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example embodiments described herein provide systems and methods for providing dynamic search content and relevant corresponding advertisements (also referred to as “ads”) to a user in an efficient and expedited manner. Example embodiments allow the user to enter a search string into a search bar comprising one or more keywords. As the user is entering (e.g., typing or speaking) the search string, the dynamic content delivery search system is already taking the keywords and preforming a matching process on-the-fly to determine search results and advertisements that match the keywords. This is done without the user having to select an “enter” key, for example. As such, as soon as the user is done entering an entire search string, and without the user having to select the “enter” key, search results and relevant advertisements are queued up to be presented to the user, and may be automatically “surfaced” around the search bar. Accordingly, there is little to no lag time in presenting the search results and relevant advertisement since the matching process is being performed before the user even finishes entering the complete search string, and the potential results and advertisement queued up (e.g., in memory or cache) for immediate delivery upon completion of entry of the search string.

In example embodiments, a search string that is used to determine search results from a publication system is received. A matching process that compares each keyword in the search string to attributes of a plurality of advertisements is performed. One or more advertisements from the plurality of advertisements that have attributes matching the search string is determined. An image corresponding to each of these one or more advertisements is presented as part a search result page, whereby the image is displayed in a same format as the search results determined from the publication system using the search string. The advertisements are relevant to the user since the advertisements have attributes that match the search string provided by the user.

As a result, one or more of the methodologies described herein facilitate performing a search and presenting corresponding results that include relevant advertisements. The relevant advertisements allow the user to quick access relevant information or products without have to randomly navigate a networked environment. When these effects are considered in aggregate, one or more of the methodologies described herein may obviate a need for certain efforts or resources that otherwise would be involved in providing content to a search request. Computing resources used by one or more machines, databases, or devices (e.g., within the network environment 100) may be reduced. Examples of such computing resources include processor cycles, network traffic, memory usage, data storage capacity, power consumption, and cooling capacity.

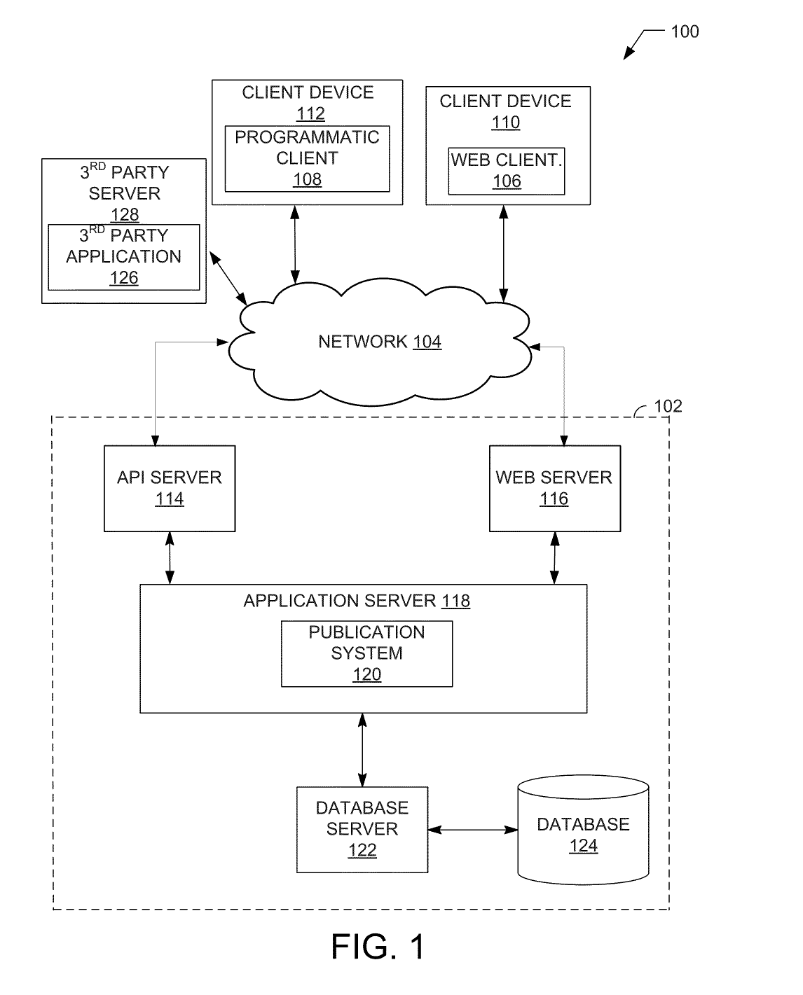

With reference to FIG. 1, an example embodiment of a high-level client-server-based network architecture 100 to provide a dynamic content delivery search system is shown. A networked system 102, in an example form of a network-server-side functionality, is coupled via a communication network 104 (e.g., the Internet, wireless network, cellular network, or a Wide Area Network (WAN)) to one or more client devices 110, 112. FIG. 1 illustrates, for example, a web client 106 operating via a browser (e.g., such as the Internet Explorer® browser developed by Microsoft® Corporation of Redmond, Wash. State), and a programmatic client 108 executing on respective client devices 110, 112.

The client devices 110, 112 may each comprise a mobile phone, desktop computer, laptop, or any other communication device that a user may utilize to access the networked system 102. In some embodiments, each client device (e.g., client device 110) may comprise a display module (not shown) to display information (e.g., in the form of user interfaces). In further embodiments, the client device may comprise one or more of a touch screen, accelerometer, camera, microphone, and Global Positioning System (GPS) device. The client devices 110, 112 may be a device of a user, which is used to trigger processing of information, perform searches, and receive results from the dynamic content delivery search system provide by the networked system 102. In one embodiment, the networked system 102 includes or is linked to a network-based marketplace that manages digital goods, publishes publications comprising product listings of products available on the network-based marketplace, and manages payments for these marketplace transactions.

Art Application Program Interface (API) server 114 and a web server 116 are coupled to, and provide programmatic and web interfaces respectively to, one or more application servers 118. The application server 118 hosts a publication system 120, which may comprise one or more modules, applications, or engines, and which may be embodied. as hardware, software, firmware, or any combination thereof The application server 118 is, in turn, coupled to one or more database servers 122 facilitating access to one or more information storage repositories or databases 124. In one embodiment, the database 124 is a storage device that stores content (e.g., product listings, store information, advertisements, videos) that may be searched by the dynamic content delivery search system.

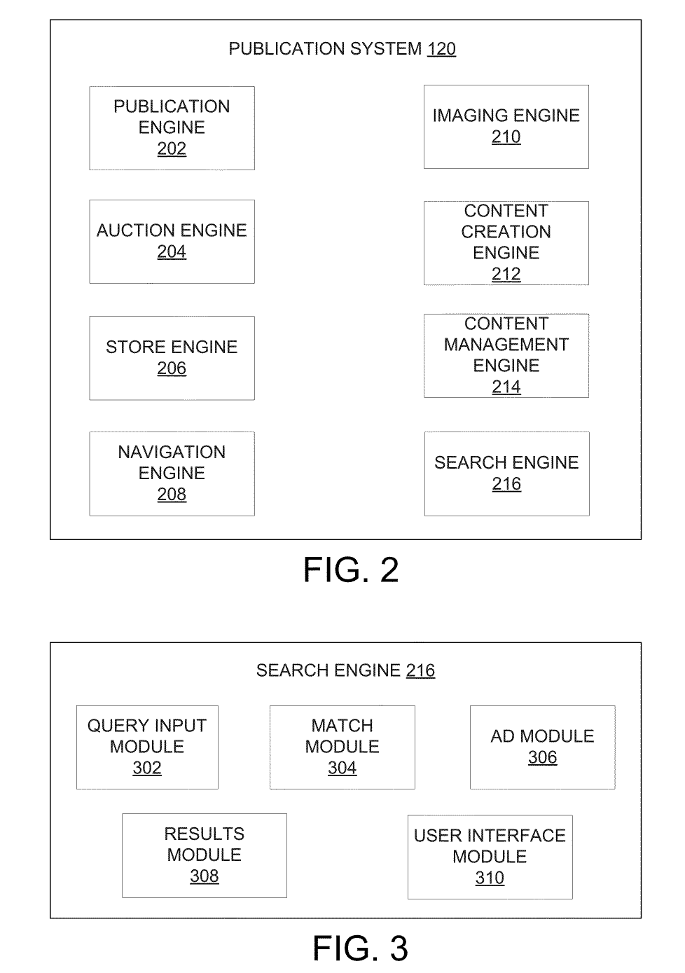

In example embodiments, the publication system 120 publishes content on a network (e.g., Internet). As such, the publication system 120 provides a number of publication functions and services to users that access the networked system 102. In example embodiments, the publication system 120 is a marketplace environment whereby a user may purchase products listed thereon. However, it is noted that the publication system 120 may, in alternative embodiments, be associated with a non-marketplace environment such as an informational (e.g., search engine) or social networking environment. The publication system 120 will be discussed in more detail in connection with FIG. 2 below.

While the publication system 120 is shown in FIG. 1 to form part of the networked system 102, it will be appreciated that, in alternative embodiments, the publication system 120 may form part of a separate service that is distinct from the networked system 102. Additionally, while the example network architecture 100 of FIG. 1 employs a client-server architecture, a skilled artisan will recognize that the present disclosure is not limited to such an architecture. The example network architecture 100 can equally well find application in, for example, a distributed or peer-to-peer architecture system. The publication system 120 may also be implemented as a standalone system or standalone software program operating under a separate hardware platform, which does not necessarily have networking capabilities. For example, the publication system 120 along with the database 124 may be entirely on the client device (e.g., client device 112), or the publication system 120 may be on the client device and have access to the separate database 124.

Referring now to FIG. 2, an example block diagram illustrating multiple components that, in one embodiment, are provided within the publication system 120 of the networked system 102 is shown. In this embodiment, the publication system 120 comprises a content delivery search system that is associated with a network-based marketplace where items (e.g., goods or services) may be offered for sale. The items may comprise digital goods (e.g., currency, license rights as well as physical goods. The publication system 120 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources, to allow information to be passed between the components or to allow the components to share and access common data. Furthermore, the components may access the one or more databases 124 via the one or more database servers 122.

The publication system 120 provides a number of publishing, listing, and price-setting mechanisms whereby a seller (e.g., individual, store, company) may list (or publish information concerning) goods or services for sale, a buyer can express interest in or indicate a desire to purchase such goods or services, and a price can be set for a transaction pertaining to the goods or services. To this end, the publication system 120 may comprise at least one publication engine 202 and one or more auction engines 204 that support auction-format listing and price setting mechanisms (e.g., English, Dutch, Chinese, Double, Reverse auctions, etc.).

A store engine 206 allows a seller to group listings within a “virtual” store, which may be branded and otherwise personalized by and for the seller. Such a virtual store may also offer promotions, incentives, and features that are specific and personalized to the seller. In one example, the seller may offer a plurality of items as Buy-It-Now items in the virtual store, offer a plurality of items for sale or auction, or a combination of both. The seller may also offer other content via their store. For example, the seller may provide recipes or videos (e.g., showing how to make or use an item).

Navigation of the publication system 120 may be facilitated by a navigation engine 208. For example, a browse module (not shown) of the navigation engine 208 allows users to browse various search results, categories, catalogs, or inventory data structures according to which content may be classified within the publication system 120. Various other navigation applications within the navigation engine 208 may be provided to supplement the browsing applications.

In order to make content available via the networked system 102 as visually informing and attractive as possible, the publication system 120 may include an imaging engine 210 that enables users to upload images or videos for inclusion within publications and to incorporate images or videos within viewed publications. The imaging engine 210 may also receive image data from a user as a search query and utilize the image data (e.g., metadata) to identify an item depicted or described by the image data. In accordance with example embodiments, the imaging engine 210 may use images or other digital content obtained from third party media hosting sites.

A content creation engine 212 allows users (e.g., sellers) to conveniently author publications, content, or listings of items. In one embodiment, the content pertains to goods or services that a user (e.g., a seller) wishes to transact via the publication system 120. In other embodiments, a user may create content that is an advertisement or other form of publication (e.g., tutorial video).

A content management engine 21.4 allows the users to manage such publications or content. Specifically, where a particular user has authored or published a large number of content, the management of such content may present a challenge. The content management engine 214 provides a number of features (e.g., auto-relisting, inventory level monitors, etc.) to assist the user in managing such content.

A search engine 216 performs searches for content including relevant corresponding advertisement in the networked system 102 that match a query (e.g., search string), queues up search results and relevant advertisements, and manages presentation of the search results and relevant advertisements. The searches (or matching process) are performed on-the-fly as the user is entering the search string. The search results and advertisement may be queued up for presentation to the user (e.g. cached) as soon as the user has completed the search string and without the user having to select an “enter” button or key. The search engine 216 will be discussed in more detail in connection with FIG. 3 below.

Although the various components of the publication system 120 have been defined in terms of a variety of individual modules and engines, a skilled artisan will recognize that many of the items can be combined or organized in other ways and that not all modules or engines need to be present or implemented in accordance with example embodiments. Furthermore, not all components of the publication system 120 have been included in FIG. 2. In general, components, protocols, structures, and techniques not directly related to functions of exemplary embodiments (e.g., pricing engine, dispute resolution engine, loyalty promotion engine, personalization engine) have not been shown or discussed in detail. The description given herein simply provides a variety of exemplary embodiments to aid the reader in an understanding of the systems and methods used herein.

FIG. 3 illustrates an example block diagram having multiple components that, in one embodiment, are provided within the search engine 216 of the publication system 12A The search engine 216 comprises a dynamic content delivery search system that performs dynamic on-the-fly matching of keywords in a search string as the user is entering the search string, determines matching search results and relevant ads, and queues up the search results and relevant ads for immediate presentation to the user upon completion of the entry of the search string. To enable these operations, the search engine 216 comprises a query input module 302, a match module 304, an ad module 306, a results module 308, and a user interface module 310 all communicatively coupled together.

As is understood by skilled artisans in the relevant computer and Internet-related arts, each component (e.g., a module or engine) illustrated in FIG. 2 and FIG. 3 may represent a set of logic (e.g., executable software instructions) and the corresponding hardware (e.g., memory and processor) for executing the set of logic. Further, each of the components (e.g., a module or engine) illustrated in FIG. 2 and FIG. 3 is communicatively coupled e.g., via appropriate interfaces) to the other components and to various data sources, so as to allow information to be passed between the components or so as to allow the components to share and access common data. Moreover, each component illustrated in FIG. 2 and FIG. 3 may be hosted on dedicated or shared server machines that are communicatively coupled to enable communications between server machines.

The query input module 302 manages operations involving input of a search string within a search box displayed on a user interface presented to a user. Accordingly, the query input module 302 detects when a search string is being entered into the search box and identifies one or more keywords of the search string. For example, as soon as a user enters a first keyword in the search string, the query input module 302 detects the entry of the keyword (e.g., detecting a space after a series of letters or detecting selection of a space bar), identifies the keyword, and passes the keyword to the match module 304. This process continues for each additional keyword of the search string.

The match module 304 performs a matching process to determine matches to one or more keywords of the search string in real-time. In example embodiments, the match module 304 receives a first keyword detected by the query input module 302 and performs a first matching process to derive search results that match the first keyword. The search results include publications from the publication system 120. The match module 304 also determines relevant corresponding advertisements that also match the first keyword during the first matching process. Subsequently, if the query input module 302 detects a second keyword in the search string (e.g., detected by another space thereafter), the match module 304 uses that second keyword to refine the matching results (e.g., the search results and the relevant advertisement) derived from the first keyword. This matching process continues until every keyword from the search string has been incorporated into the matching process. An end of the search string may be detected, for example, by a space or a pause in entry of any further keywords.

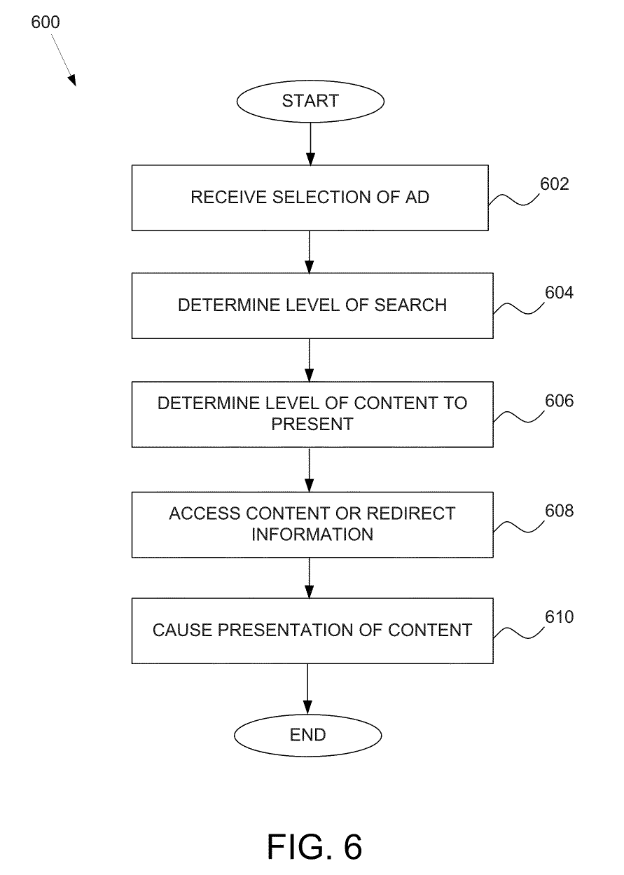

The ad module 306 manages advertisements within the publication system 120. In example embodiments, each advertisement is tagged, by the ad module 306, with data (e.g., metadata) that identifies attributes of the advertisement. The attributes may include or describe, for example, a store name, categories of products, sub-categories of products, and individual product corresponding to the image. In example embodiments, the match module 304 performs a matching process against these attributes of the advertisements in order to determine the relevant advertisements that match a search string. Further still, the ad module 306 (in conjunction with the results module 308) determines what content to provide to the user when a particular image of an advertisement is selected by the user. The determination process will be discussed in more detail in connection with FIG. 6 below. In example embodiments, a particular store or advertiser may have multiple advertisements manages by the ad module 306. In these embodiments, the attributes for each of the advertisements will indicate which of the multiple advertisements should be selected for presentation.

The results module 308 manages operations involving processing the results (e.g., both the search results and the relevant advertisements) prior to presenting the results to the user. In example embodiments, the results module 306 determines a level of a current or previous search, results, or search result page. Based on the level of the current or previous search, results, or search result page, different versions of content may be retrieved for presentation to the user. For example, if the level of the previous search results was at a category level (e.g., furniture), then a current search result building off of the previous search result (e.g., refining the previous search result or search string) may be at a sub-category level (e.g., sofas). In some embodiments, the level may be tagged on each image of the results by the user interface module 310, for example, when the images are causes to be displayed to the user. In these cases, the results module 308 determines the level from a tag associated with the image.

The user interface module 310 manages operations for causing presentation of the results to the user (e.g., on a display of a client device of the user). In example embodiment, the user interface module 310 causes the results to be present in a graphical format on one or more sides of a search bar or box. Accordingly, the user interface module 310 accesses images for the results including the relevant overlay advertisements, and sends instructions and corresponding data to the client device of the user (e.g., client device 110) to present such a user interface.

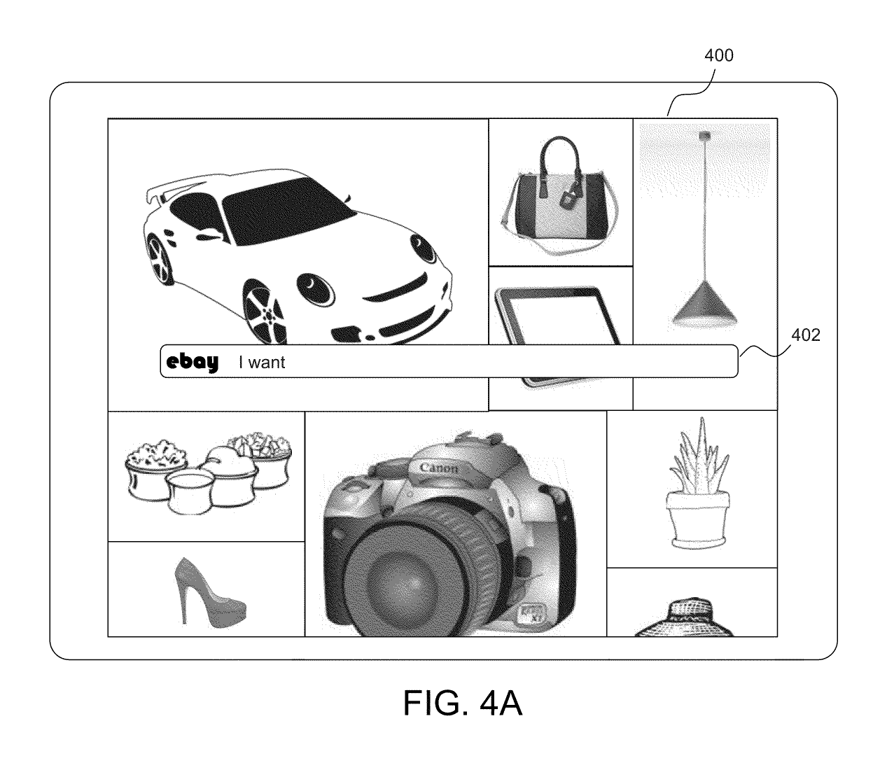

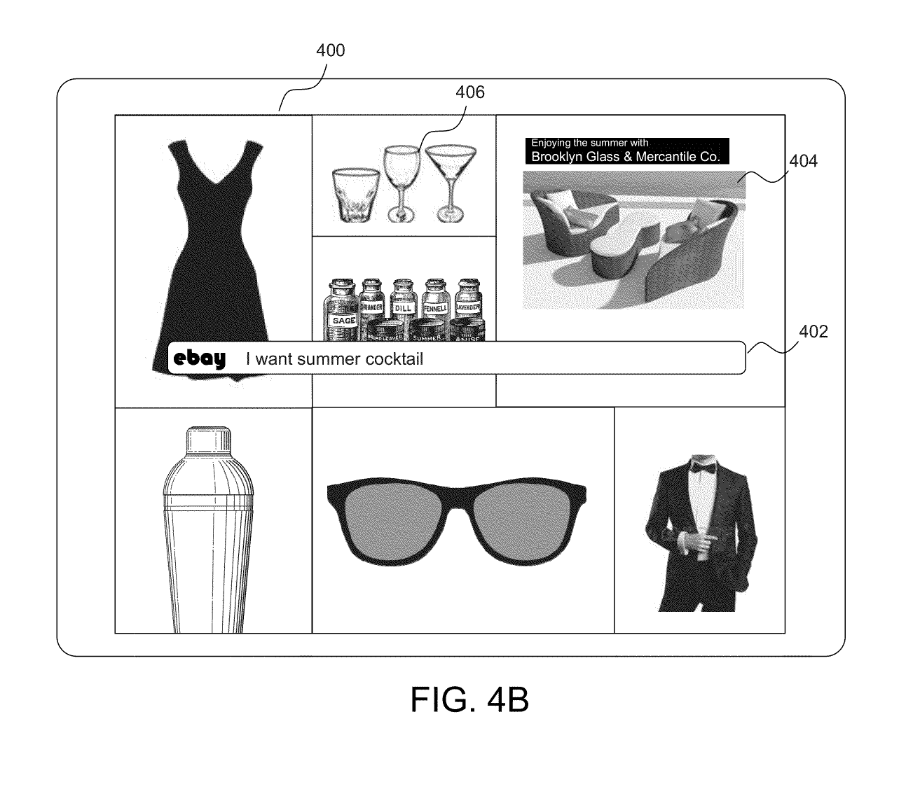

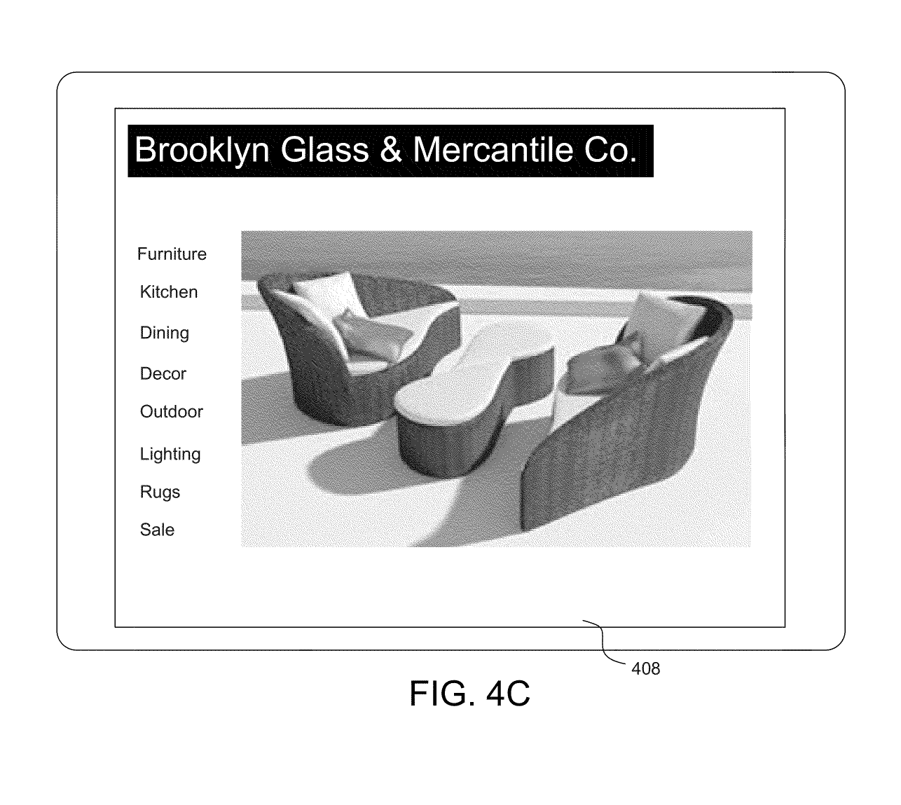

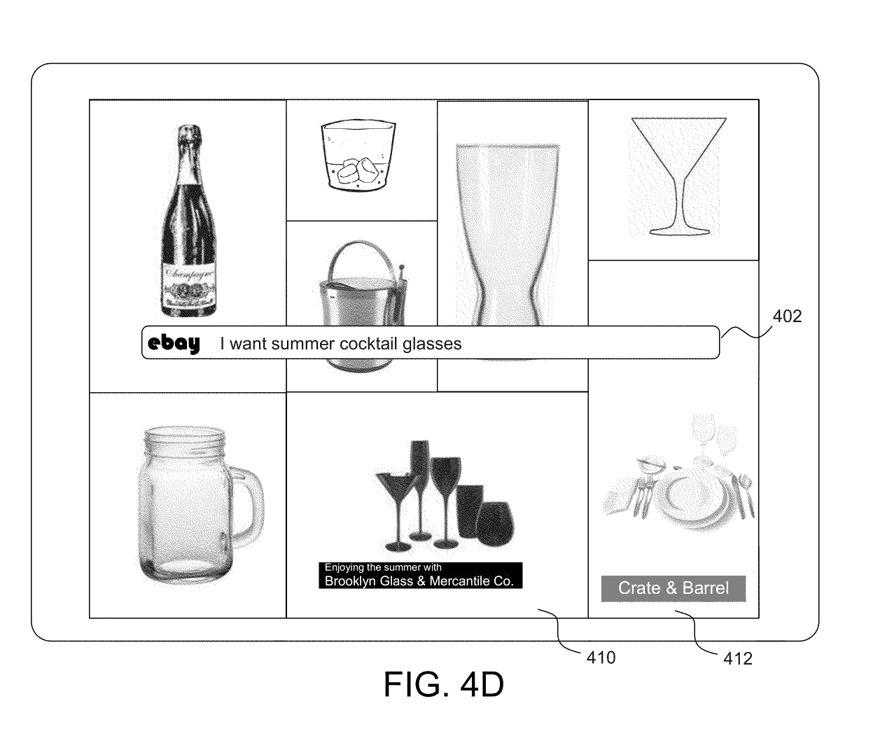

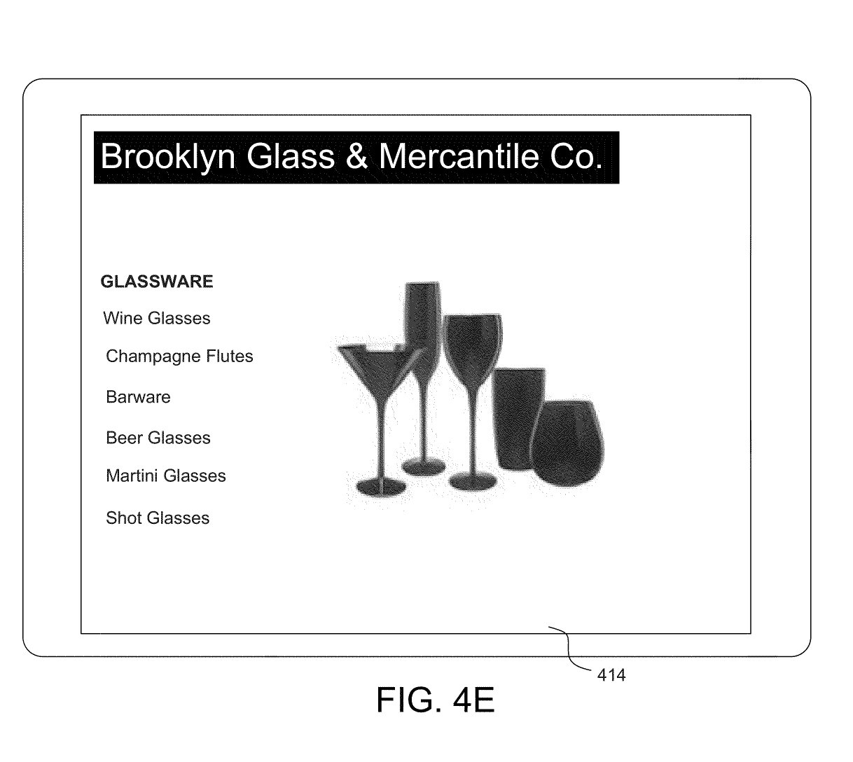

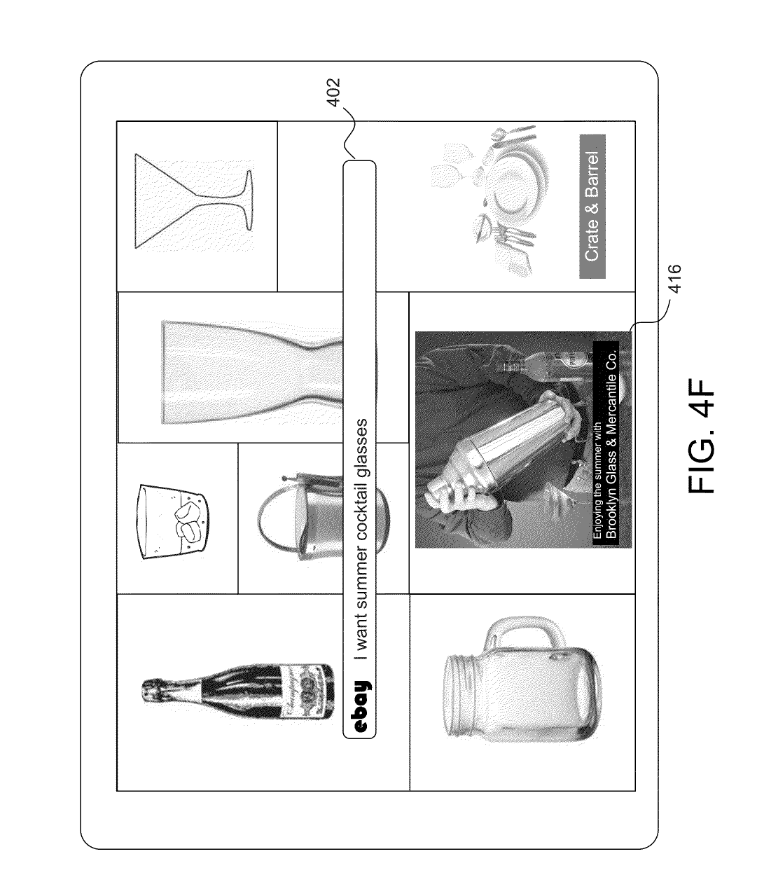

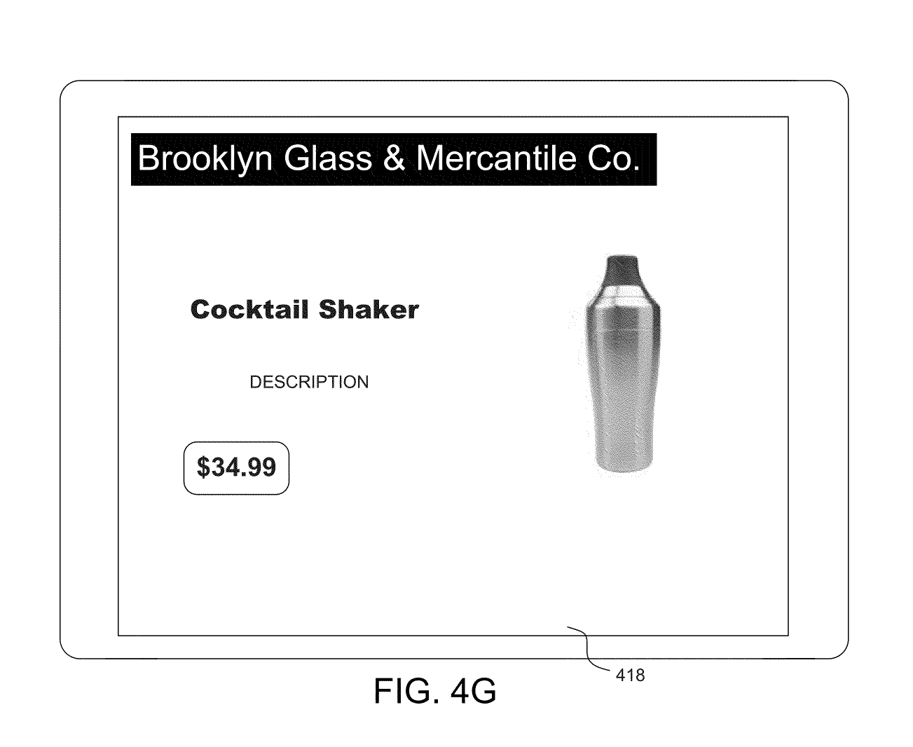

FIGS. 4A-4G are example user interfaces presented by the dynamic content delivery search system (e.g., via the user interface module 310). FIG. 4A show a user interface 400 comprising a home page where a user starts a search query. As illustrated, the user interface 400 includes a search bar 402 where the user can enter a search string.

The user interface 400 also provides a plurality of content shown as images from which the user may select to append to a present search string. The plurality of content may be personalized to the user in instances where the user is known to the publication system 120 (e.g., via a cookie, logged in with the publication system 120). For example, the content displayed on the home page may comprise categories of items that the user has previously purchased, has performed previously searches on, owns, has shown interest in, or any combination therein.

Referring now to FIG. 4B, the user has entered “summer cocktail” as the search string. In response, various images that correspond to categories or advertisements that may be related to “summer cocktail” are “surfaced” or displayed around the search bar 402 as the user types “summer cocktail.” In sonic embodiments, various results (e.g., search results and relevant advertisement) may be displayed as each keyword of the search string is entered. For example, after the user types “summer” a set of images may be displayed around the search bar 402. As the user continues entering the remainder of the search string (e.g., types “cocktail”), the images displayed around the search bar 402 are refined to display categories, images, or advertisements that correspond to “summer cocktail,” other embodiments, the images are not displayed until the user has completed the entry of the search string. However, the search engine 216 is dynamically curating and creating the results based on what the user is entering in the search bar 402 as the user is entering the keywords, whereby results are queued up in a backend (e.g., the publication system 120). As more keywords are appended in the search bar 402, the queued up results are refined. As a result, the results can be returned faster than in embodiments where the processing of a search string does not occur until after the user selects an “enter” key. In example embodiments, the images displayed on the user interface 400 may be tagged to indicate a level of the search or results (e.g., “category” level or “level 1”),

As shown in the example user interface of FIG. 4B, the various categories of the search results include, for example, eyeglasses, drinking glasses, women's clothing, men's clothing, barware, and furniture. Additionally, an overlay ad 404 is included in the results. Accordingly, the overlay ad 404 has attributes that match “summer cocktail.” The overlay ad 404 is presented in a format that makes the overlay ad 404 appear as if it is just another one of the search results, thus contributing to a uniform look for the user interface 400.

If the user selects the overlay ad 404, the user may then be presented with a user interface of a storefront 408 (e.g., homepage of a store “Brooklyn Glass & Mercantile Co.”) corresponding to the selected overlay ad 404 as shown in FIG. 4C. The user interface of the storefront 408 may be served by the publication system 120 (e.g., as a virtual store of the publication system 120) or be a webpage associated with a physical or virtual store external to the publication system 120. In embodiments where the webpage is external to the publication system, the user may be redirected to an external site corresponding to the store.

Because the overlay ad 404 was presented in a category level or first level of results or search result page, selection of the overlay ad 404 results in presentation of more generic content. As such, the storefront 408 for the Brooklyn Glass & Mercantile Company is presented. In one embodiment, each one of the displayed images is tagged (e.g., with metadata) to indicate a current level in a search. For example, returned results for “summer cocktail” represent categories (visual category representations). The level of the overlay ad 404 may be determined from a tag associated with the overlay ad 404 when the overlay ad 404 was caused to be presented in the user interface of FIG. 4B.

Referring back to FIG. 4B, the user can select an image corresponding to one of the categories shown on the user interface 400 to refine the search. For example, the user can select an image 406 corresponding to drinking glasses. By selecting this image, one or more keywords associated with the selected image are appended to the search string. For instance, the query input module 302 determines the one or more keywords from metadata associated with the selected image. The one or more keywords are appended to the search string by the user interface module 310 and used by the match module 304 to refine the present search results. Referring now to FIG. 4D, the search bar 402 now shows an addition of the keyword “glasses” resulting in a new search string “summer cocktail glasses.” Accordingly, a selection of a visual representation or image can be used to refine the search.

The one or more keywords appended to the search string are dependent on the level of the search, results, or search result page. As previously discussed, each one of the displayed images may be tagged (e.g., with an additional piece of metadata) to indicate the current level in the search, results, or search result page. As such, the search engine 216 detects that the image corresponding to “drinking glasses” has a tag of “category.” Therefore, a selection of “drinking glasses” from the category level will indicate to the search engine 216 to append a keyword that corresponds to the category level and return results in a sub-category (e.g., products, stores) corresponding to drinking glasses. As a further example, if the current level were the sub-category of drinking glasses, then selection of an image displaying drinking glasses causes a keyword that corresponds to a sub-category level to be appended and return results at an item level (e.g., individual items available for purchase, types of drinking glasses).

As shown in FIG. 4D, images corresponding to the search string “summer cocktail glasses” are now displayed around the search bar 402. The images may correspond to sub-categories related to summer cocktail glasses and include overlay ads 410 and 412. For example, images corresponding to types of drinking glasses, accessories related to drinking glasses, and ingredients related to cocktails are displayed in FIG. 4D.

Because the results shown on the user interface of FIG. 4D are a level lower than those shown in FIG. 4B (e.g., sub-category or level 2), the overlay ads 410 and 412 may be more specific. For example, the overlay ad 410 for Brooklyn Glass & Mercantile Company now shows various drinking glasses. In alternative embodiments, the overlay ad shown may be the same as for the previous level (e.g., overlay ad 404). However, the selection of the overlay ad 410 (or a version of overlay ad 404 displayed on the user interface of FIG. 4D) results in different and more specific content than that provided based on a selection from the user interface of FIG. 4B since the results correspond to a lower level of the search or results.

Referring now to FIG. 4E, a user interface 414 resulting from the selection of the overlay ad 410 from FIG. 4D is shown. Since the selection of the overlay ad 410 was from a lower level of the results (e.g., based on “summer cocktail glasses”), the selection of the overlay ad 410 results in presentation of the user interface 414 having more specific content corresponding to the current level of the results. Accordingly, instead of presenting the storefront as shown in FIG. 4C, the user interface 414 showing various categories of glassware from the Brooklyn Glass & Mercantile Company is presented. From here, the user may select any of the categories of glassware to view corresponding product information. As with the user interface of the storefront 408, the user interface 408 may be served by the publication system 120 (e.g., as a virtual store of the publication system 120) or be a webpage associated with a physical or virtual store external to the publication system 120.

While the embodiments of FIG. 4D and 4E results in presentation of specific content from an advertiser that directs the user to categories of goods, for example, alternatively, the selection of an overlay ad may result in presentation of individual products. Referring now to FIG. 4F, an alternative user interface displaying results for the search string “summer cocktail glasses” is shown. In this embodiment, a different overlay ad 416 is presented on the user interface. In this embodiment, the overlay ad 416 shows particular products available from the Brooklyn Glass & Mercantile Company. If the user selects the overlay ad 416, the user is presented with a product page 418 as shown in FIG. 4G.

While different images were used as the overlay ad for the Brooklyn Glass & Mercantile Company dependent on the level of the results or search result page, alternative embodiments may contemplate having a same image used for one or more of the levels of the results. However, depending on the level of the results, the selection of the overlay ad with the same image will result in presentation of a different set of content. For example, selection of the overlay ad in a category or first level of the results may result in presentation of a storefront for a store associated with the overlay ad. In contrast, selection of the same overlay ad in a sub-category or second level of the results may result in presentation of a subcategory webpage or more specific webpage from the store(e.g., user interface displaying types of glassware from the store). The determination of what content webpage, user interface) to present to the user is based on the current level of the search or results. The current level may be determined, for example, from a tag that is assigned to the overlay ad when the overlay ad is caused to be presented in the current results,

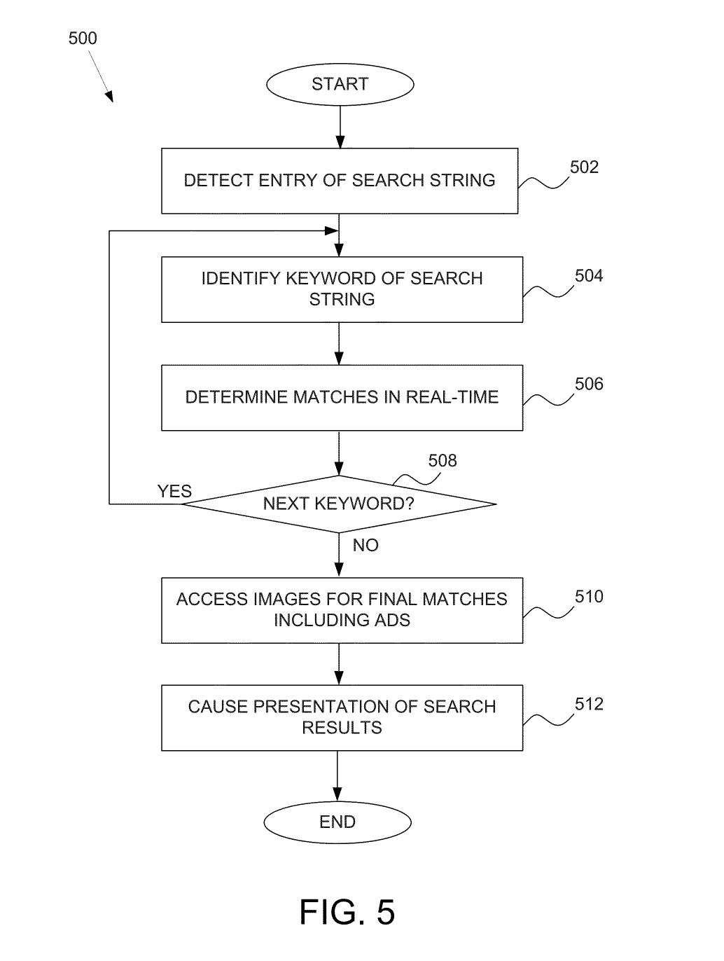

FIG. 5 is a flow diagram of an example method 500 for providing dynamic search content including relevant advertisement in a search system. In example embodiments, the search engine 216 dynamically performs matches as a search string is being entered in a search box or bar and queues up the results including advertisements for presentation. The user is not required to select an “enter” key in order to obtain results. As such, entry of a search string is detected in operation 502. The query input module 302 detects entry of a search string being entered in the search bar in substantially real-time (e.g., detecting keystrokes, characters, or numbers).

In operation 504, a keyword of the search string is identified. In example embodiments, the query input module 302 identifies each keyword as it is being entered in the search bar. For example, as soon as a user enters a first keyword in the search string, the query input module 302 detects and identifies the first keyword (e.g., “summer”). In one embodiment, the query input module 302 detects completion of entry of the first keyword based on a space after the keyword.

The keyword is then passed to the match module 304 where, in operation 506, matches to the keyword are determined in real-time. In example embodiments, the match module 304 receives the keyword detected by the query input module 302 and performs a matching process to derive results that match the keyword. The results include publications from the publication system 120 that match the keyword and may also include matching advertisements. The advertisements are matched based on attributes that are tagged (e.g., metadata) to the advertisement. As a result, matching results that match the keyword are determined and ready to be presented to the user (e.g., queued up for delivery).

In operation 508, a determination is made as to whether there is a next keyword in the search string. For example, the query input module 302 determines whether a next or subsequent keyword is entered for the search string. If a next keyword is detected, the method returns to operation 504 whereby the next keyword (e.g., “cocktail”) is identified and used, in operation 506, to refine the previous matching results based on the first keyword.

This matching process continues until every keyword from the search string has been incorporated into the matching process. The addition of each keyword refines the previous matching results As such, the matching process becomes significantly faster and requires less processing power with each iteration since the next keyword matches a smaller set of previous matching results.

Once no further keywords are detected (e.g., entry of the search string is completed), images of the final matches of the results (e.g., search results and advertisements) are accessed in operation 510. Accordingly, the user interface module 308 accesses the images from a database or repository storing, for example, publication information (e.g., database 124). The images may comprise images from third parties or stores, images from a catalog, images uploaded by various entities via the imaging engine 210, or any combination of these.

Images of matching advertisements may comprise or be associated with attributes that indicate which image from a same advertiser should be used in presenting the results. In some cases, the attributes may specify that a particular image should be used for an indicated period of time. For example, a first image may have attributes that indicate that it should be used during a summer time frame, while a second image has attributes that indicate that it should be used during a winter time frame. As a result, a matching advertisement for an example search string of “cocktail glasses” during the summer time frame may utilize an image of cocktail glasses in an outdoor scene, while the same search string during the winter time frame returns an image of cocktail glasses surrounded by holiday decorations. In other cases, the same image may be used for different levels of the results. However, the content presented in response to the selection of the same image will b different based on the level of the search results.

In operation 512, the search results are caused to be displayed on the client device (e.g., the client device 110) of the user. In example embodiments, the user interface module 308 sends instructions and data (e.g., image data) to the client device of the user to present a. user interface whereby the images of the search results are displayed (e.g., above, below, or around the search bar).

Referring now to FIG. 6, a flow diagram of an example method 600 for providing content corresponding to a selected advertisement is shown. In operation 602, a selection of an overlay ad is received. In example embodiment, the query input module 302 receives the selection of the overlay ad.

In operation 604, a level of the current results is determined. In one embodiment, a determination is made as to a level of the selected overlay ad. The determination may be made by the ad module 306 or the results module 308 in example embodiments. In this embodiment, the selected overlay ad may be tagged to indicate a current level in the search result page (e.g., category level, sub-category level) when it is caused to be displayed to the user. Accordingly, the level of the search result page (or level of search or level of results) is determined from the tag.

In operation 606, a level of content to be presented is determined in operation The determination may be made by the ad module 306 or the results module 308 in example embodiments. For example, if the current level of the results presents (category) results for “summer cocktail” and the user selects an overlay ad corresponding to the Brooklyn Glass Mercantile Company, content to be presented may be a storefront or homepage for the Brooklyn Glass & Mercantile Company. However, if the current level of the results presents (sub-category) results for “summer cocktail glasses” and the same overlay ad corresponding to the Brooklyn Glass & Mercantile Company is selected, then the content to be presented may be a specific page for the Brooklyn Glass & Mercantile Company (e.g., glassware page).

In operation 608, content or redirect information is accessed based on the level of content to be presented determined in operation 606. In some embodiments, the content to be presented in response to the selection of the overlay ad is content from the publication system 120. For example, content from a virtual store that is managed by the store engine 206 may be retrieved from the database 124. In other cases, the user may be redirected to a page that is external to the publication system 120. In these cases, the redirect information is determined. A location of the content and the redirect information may be stored as an attribute associated with the image of the overlay ad or be stored separately in a table whereby entries of the table correspond to images or overlay ads.

In operation 610, the content is caused to be displayed on the user device of the user. In example embodiments, the user interface module 308 sends instructions and data (e.g., image data) to the client device of the user to present a user interface displaying the content corresponding to the selected overlay ad.

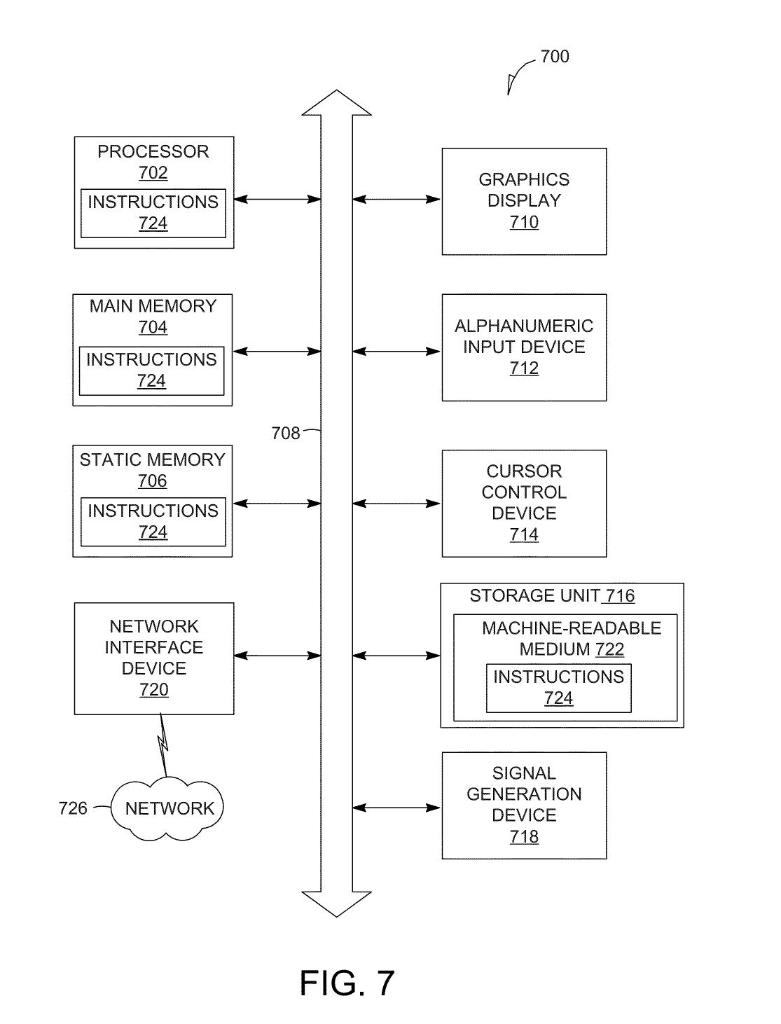

FIG. 7 is a block diagram illustrating components of a machine 700, according to some example embodiments, able to read instructions 724 from a machine-readable medium 722 (e.g., a non-transitory machine-readable medium, a machine-readable storage medium, a computer-readable storage medium, or any suitable combination thereof) and perform any one or more of the methodologies discussed herein, in whole or in part. Specifically, FIG. 7 shows the machine 700 in the example form of a computer system (e.g., a computer) within which the instructions 724 (e.g., software, a program, an application, an applet, an app, or other executable code) for causing the machine 700 to perform any one or more of the methodologies discussed herein may be executed, in whole or in part.

In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724, sequentially or otherwise, that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (MC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a graphics display 710 (e.g., a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a cursor control device 714 (e.g., a mouse, a touchpad, trackball, a joystick, a motion sensor, an eye tracking device, or other pointing instrument), a storage unit 716, a signal generation device 718 (e.g., a sound card, an amplifier, a speaker, a headphone jack, or any suitable combination thereof), and a network interface device 720.

The storage unit 716 includes the machine-readable medium 722 (e.g., a tangible and non-transitory machine-readable storage medium) on which are stored the instructions 724 embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered machine-readable media (e.g., tangible and non-transitory machine-readable media).

In some example embodiments, the machine 700 may be a portable com device, such as a smart phone or tablet computer, and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions. The term “machine-readable medium ” shall also be taken to include any medium, or combination of multiple media, that is capable of storing instructions for execution by a machine (e.g., machine 700), such that the instructions, when executed by one or more processors of the machine (e.g., processor 702), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Furthermore, the tangible machine-readable medium is non-transitory in that it does not embody a propagating signal. However, labeling the tangible machine-readable medium as “non-transitory” should not be construed to mean that the medium is incapable of movement the medium should be considered as being transportable from one physical location to another. Additionally, since the machine-readable medium is tangible, the medium may be considered to be a machine-readable device.

The instructions 724 may further be transmitted or received over a communications network 726 using a transmission medium via the network interface device 720 and utilizing any one of a number of well-known transfer protocols (e.g., HTTP). Examples of communication networks include a local area network (LAN), a wide area network (WAN), the Internet, mobile telephone networks, plain old telephone service (TOTS) networks, and wireless data networks (e.g., WiFi, LTE, and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive unless specifically stated otherwise,

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed,

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A machine-readable medium having no transitory signals and in storing instructions which, when executed by the at least one processor of a machine, cause the machine to perform operations comprising:
receiving a search string that is used to determine search results from a publication system;
performing a matching process that compares each keyword in the search string to attributes of a plurality of advertisements;
determining an advertisement from the plurality of advertisements that has attributes matching the search string; and
causing presentation of an image corresponding to the advertisement as part a search result page, the causing the presentation comprising causing display of the image corresponding to the advertisement in a same format as the search results determined from the publication system using the search string.

2. The machine-readable medium of claim 1, wherein the performing the matching process comprises:
identifying a first keyword of the search string;
determining a first set of matching advertisements that match the first keyword;
identifying a second keyword of the search string; and
using the second keyword, refining the first set of matching advertisements that match the first keyword to obtain a refined set of matching advertisements, the refined set including the advertisement caused to be presented.

3. The machine-readable medium of claim 1 wherein the operations further comprise:
receiving a selection of the image corresponding to the advertisement displayed on the search result page;
determining a current level associated with the search result page; and
based on the current level, determining a level of content to present in response to the selection.

4. The machine-readable medium of claim 3, wherein the operations further comprise tagging the image corresponding to the advertisement with a tag indicating the current level of the search result page, the determining the current level comprising accessing the tag.

5. The machine-readable medium of claim 3, wherein the operations further comprise:
accessing content corresponding to the selected image based on the current level; and
causing presentation of the content in a new user interface.

6. The machine-readable medium of claim 3, wherein the operations further comprise:
accessing redirect information corresponding to the selected image based on the current level; and
using the redirect information, redirecting a device of a user that selected the image to a page external to the publication system.

7. The machine-readable medium of claim 1, wherein the causing presentation of the image corresponding to the advertisement comprises:
accessing images corresponding to the advertisement; and
selecting the image corresponding to the advertisement based on a time frame indicated as an attribute of the image.

8. A method comprising:
receiving a search string that is used to determine search results from a publication system;
performing, by a hardware processor, a matching process that compares each keyword in the search string to attributes of a plurality of advertisements;
determining an advertisement from the plurality of advertisements that has attributes matching the search string; and
causing presentation of an image corresponding to the advertisement as part a search result page, the causing the presentation comprising causing display of the image corresponding to the advertisement in a same format as the search results determined from the publication system using the search string.

9. The method of claim 9, wherein the performing the matching process comprises:
identifying a first keyword of the search string;
determining a first set of matching advertisements that match the first keyword;
identifying a second keyword of the search string; and
using the second keyword, refining the first set of matching advertisements that match the first keyword to obtain a refined set of matching advertisements, the refined set including the advertisement caused to be presented.

10. The method of claim 9, further comprising:
receiving a selection of the image corresponding to the advertisement displayed on the search result page;
determining a current level associated with the search result page; and
based on the current level, determining a level of content to present in response to the selection.

11. The method of claim 10, further comprising tagging the image corresponding to the advertisement with a tag indicating the current level of the search result page, the determining the current level comprising accessing the tag.

17. The method of claim 10, further comprising:
accessing content corresponding to the selected image based on the current level; and
causing presentation of the content a new user interface.

13. The method of claim 10, further comprising:
accessing redirect information corresponding to the selected image based on the current level; and
using the redirect information, redirecting a device of a user that selected the image to a page external to the publication system.

14. The method of claim 9, wherein the causing presentation of the image corresponding to the advertisement comprises:
accessing images corresponding to the advertisement; and
selecting the image corresponding to the advertisement based on a time frame indicated as an attribute of the image.

15. A system comprising:
a query input module to receive a search string that is used to determine search results from a publication system;
a match module comprising a hardware processor and configured to perform a matching process that compares each keyword in the search string to attributes of a plurality of advertisements, and to determine an advertisement from the plurality of advertisements that has attributes matching the search string; and
a user interface module to cause presentation of an image corresponding to the advertisement as part a search result page, the presentation comprising display of the image corresponding to the advertisement in a same format as the search results determined from the publication system using the search string.

16. The system of claim 15, wherein the match module performs the matching process by performing operations comprising:
identifying a first keyword of the search string;
determining a first set of matching advertisements that match the first keyword;
identifying a second keyword of the search string; and
using the second keyword, refining the first set of matching advertisements that match the first keyword to obtain a refined set of matching advertisements, the refined set including the advertisement caused to be presented.

17. The system of claim 15, wherein the query input module is further to receive a selection of the image corresponding to the advertisement displayed on the search result page;
the system farther comprising an ad module to:
determine a current level associated with the search result page; and
based on the current level, determine a level of content to present in response to the selection.

18. The system of claim 17, wherein the user interface module is further to tag the image corresponding to the advertisement with a tag indicating the current level of the search result page, the determining the current level comprising accessing the tag.

19. The system of claim 17, further comprising an ad module to access content corresponding to the selected image based on the current level, wherein the user interface module is to further cause presentation of the content in a new user interface.

20. The system of claim 17, further comprising an ad module to access redirect information corresponding to the selected image based on the current level, wherein the user interface module is further to, using the redirect information, redirect a device of a user that selected the image to a page external to the publication system.
